(19) United States
(12) Patent Application Publication
(10) Pub. No.: US 2021/0270419 A1
(43) Pub. Date: Sep. 2, 2021

(54) HIGH-PRESSURE TANK AND MANUFACTURING METHOD OF HIGH-PRESSURE TANK

(71) Applicant: TOYOTA JIDOSHA KABUSHIKI KAISHA, Toyota-shi (JP)

(72) Inventors: Masayoshi TAKAMI, Hamamatsu-shi (JP); Yoshihiro NAKATA, Okazaki-shi (JP)

(73) Assignee: TOYOTA JIDOSHA KABUSHIKI KAISHA, Toyota-shi (JP)

(21) Appl. No.: 17/178,667

(22) Filed: Feb. 18, 2021

(30) Foreign Application Priority Data
Mar. 2, 2020 (JP) 2020-035147

(51) Int. Cl. F17C 1/02

(52) U.S. Cl. CPC F17C 1/02; F17C 2203/0604; F17C 2201/0109; F17C 2203/0621; F17C 2209/232; F17C 2203/0663; F17C 2203/012

(57) ABSTRACT

A liner of a high-pressure tank is made of a material having a shrinkage amount that is calculated by an equation below being 0 or less, the equation being shrinkage amount=−1.533538e−03*x1−3.82355406*x2−7.81992308*x3+1.89342646e−01*x4−7.84558163e−03*x5+1.15956871e−03*x1x2+6.29564353e−04*x1x3−9.34550213e−06*x1x4−6.59253799e−04*x1x5−1.52692282e+00*x2\hat{ }2+1.67290964e+00*x2x3−1.85202252e−02*x2x4−1.79615713e+00*x2x5+2.37163664e+00*x3\hat{ }2−1.17467786e−02*x3x4−9.04442817e−01*x3x5−1.86321584e−03*x4\hat{ }2+6.62631756e−03*x4x5+1.27572698e*x5\hat{ }2.

### CROSS-REFERENCE TO RELATED APPLICATION

This application claims priority to Japanese Patent Application No. 2020-035147 filed on Mar. 2, 2020, incorporated herein by reference in its entirety.

### BACKGROUND

### 1. Technical Field

The disclosure relates to a high-pressure tank and a manufacturing method of the high-pressure tank.

### 2. Description of Related Art

As a high-pressure tank such as a hydrogen tank mounted on a fuel cell vehicle or a hydrogen vehicle, a high-pressure tank including a substantially cylindrical liner, a reinforcement layer that is made of a fiber reinforced resin material covering an outer surface of the liner, and a neck that communicates with a portion inside the liner is known, such as a high-pressure tank described in Japanese Unexamined Patent Application Publication No. 2019-183935 (JP 2019-183935 A), for example. The liner further includes a cylindrical portion and dome portions disposed at respective ends of the cylindrical portion in an axial direction.

### SUMMARY

Recently, in order to reduce a weight of the high-pressure tank, reduction of a thickness of the liner has been considered. However, temperature changes occur repeatedly due to repeated use of the high-pressure tank from the time when the high-pressure tank is fully charged to the time when the high-pressure tank is empty. The temperature changes above cause the liner to repeat expansion and shrinkage. Therefore, if the thickness of the liner is reduced, a strength of the high-pressure tank may be deteriorated.

The disclosure provides a high-pressure tank capable of ensuring a tank strength even when the thickness of the liner is reduced, and a manufacturing method of the high-pressure tank.

A high-pressure tank according to an aspect of the disclosure includes a liner including a cylindrical portion and dome portions disposed at respective ends of the cylindrical portion in an axial direction of the cylindrical portion. The liner is made of a material having a shrinkage amount that is calculated by an equation below being 0 or less. The equation is shrinkage amount=−1.533538e−03*x1−3.82355406*x2−7.81992308*x3+1.89342646e−01*x4−7.84558163e−03*x5+1.15956871e−03*x1x2+6.29564353e−04*x1x3−9.34550213e−06*x1x4−6.59253799e−04*x1x5−1.52692282e+00*x2\hat{ }2+1.67290964 e+00*x2x3−1.85202252e−02*x2x4−1.79615713e+00*x2x5+2.37163664e+00*x3\hat{ }2−1.17467786e−02*x3x4−9.04442817e−01*x3x5−1.86321584e−03*x4\hat{ }2+6.62631756 e−03*x4x5+1.27572698e*x5\hat{ }2, where x1 denotes a minimum working pressure of the high-pressure tank, x2 denotes a radius of a boundary portion between the cylindrical portion and each of the dome portions, x3 denotes a thickness of the liner, x4 denotes a linear expansion coefficient of the liner, and x5 denotes Young's modulus of the liner.

In the high-pressure tank according to the aspect above, the liner is made of the resin material having the shrinkage amount that is calculated using the equation above being 0 or less. Therefore, the shrinkage amount of the liner due to temperature changes can be reduced to 0. Consequently, the strength of the high-pressure tank can be ensured even when the thickness of the liner is reduced.

The high-pressure tank according to the aspect above may further include a reinforcement layer configured to cover an outer surface of the liner. The reinforcement layer and the liner may be adhered to each other. With the configuration above, creation of a clearance between the reinforcement layer and the liner can be suppressed.

A manufacturing method of a high-pressure tank according to another aspect of the disclosure includes: a liner forming step of forming a liner including a cylindrical portion and dome portions disposed at respective ends of the cylindrical portion in an axial direction of the cylindrical portion; and a reinforcement layer forming step of forming a reinforcement layer configured to cover an outer surface of the liner. One of the liner forming step and the reinforcement layer forming step is performed, and then the other of the liner forming step and the reinforcement layer forming step is performed. In the liner forming step, the liner is formed of a material having a shrinkage amount that is calculated using an equation below being 0 or less. The equation is shrinkage amount=−1.533538e−03*x1−3.82355406*x2−7.81992308*x3+1.89342646e−01*x4−7.84558163e−03*x5+1.15956871e−03*x1x2+6.29564353e−04*x1x3−9.34550213e−06*x1x4−6.59253799e−04*x1x5−1.52692282e+00*x2\hat{ }2+1.67290964 e+00*x2x3−1.85202252e−02*x2x4−1.79615713e+00*x2x5+2.37163664e+00*x3\hat{ }2−1.17467786e−02*x3x4−9.04442817e−01*x3x5−1.86321584e−03*x4\hat{ }2+6.62631756 e−03*x4x5+1.27572698e*x5\hat{ }2, where x1 denotes a minimum working pressure of the high-pressure tank, x2 denotes a radius of a boundary portion between the cylindrical portion and each of the dome portions, x3 denotes a thickness of the liner, x4 denotes a linear expansion coefficient of the liner, and x5 denotes Young's modulus of the liner.

In the manufacturing method of the high-pressure tank according to the aspect above, in the liner forming step, the liner is formed of the resin material having the shrinkage amount that is calculated using the equation above being 0 or less. Therefore, the shrinkage amount of the liner due to temperature changes can be reduced to 0. Consequently, the strength of the high-pressure tank can be ensured even when the thickness of the liner is reduced.

In the manufacturing method of the high-pressure tank according to the aspect above, in the reinforcement layer forming step, a resin impregnated in a fiber may be used. The resin impregnated in the fiber may be the same as a material forming the liner. After performing the liner forming step and the reinforcement layer forming step, the liner and the reinforcement layer may be cured simultaneously. The liner and the reinforcement layer formed by the method above can be cured simultaneously. Therefore, compared with the case where the liner is formed of a different resin material from the material used for forming the reinforcement layer and the liner and the reinforcement layer are cured at different timings, the number of the manufacturing steps can be reduced.

According to the disclosure, the strength of the high-pressure tank can be ensured even when the thickness of the liner is reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view showing a configuration of the high-pressure tank;

FIG. 2 is a diagram showing correlation coefficients among a thickness, Young's modulus, and a linear expansion coefficient, and a shrinkage amount;

FIG. 3 is a contour diagram showing a relationship between the linear expansion coefficient, Young's modulus, and the shrinkage amount; and

FIG. 4 is a diagram showing a relationship between a predicted shrinkage amount and a CAE calculated shrinkage amount.

### DETAILED DESCRIPTION OF EMBODIMENTS

Hereinafter, an embodiment of a high-pressure tank and a manufacturing method of the high-pressure tank according to the disclosure will be described with reference to the drawings.

Configuration of High-Pressure Tank

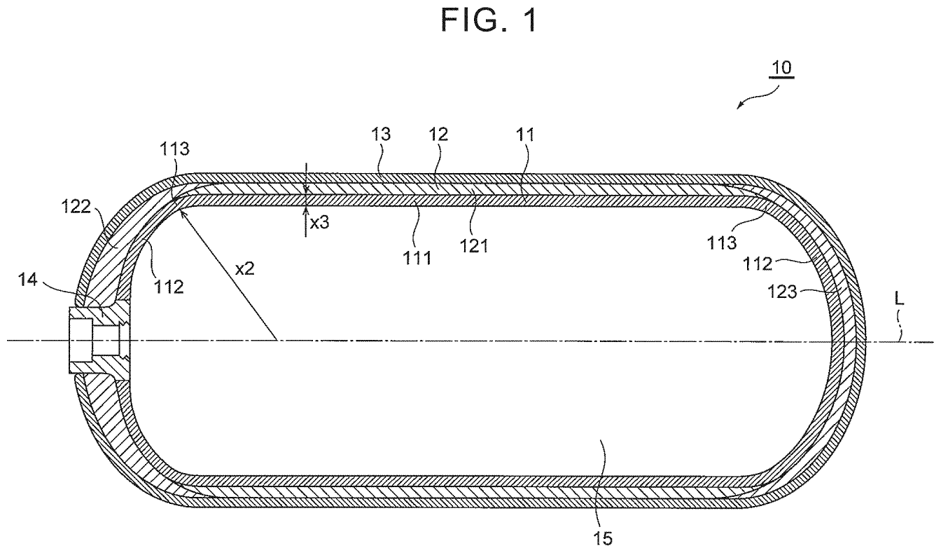

FIG. 1 is a schematic sectional view showing a configuration of the high-pressure tank. A high-pressure tank 10 is a substantially cylindrical high-pressure gas storage container having dome-shaped rounded ends. The high-pressure tank 10 includes a liner 11 having a gas barrier property and a first reinforcement layer 12 that is made of a fiber reinforced resin material covering the outer surface of the liner 11, and a second reinforcement layer 13 made of a fiber reinforced resin material covering the outer surface of the first reinforcement layer 12. A circular opening (not shown) is provided at one end of the high-pressure tank 10 in an axial direction L, and a substantially cylindrical neck 14 is attached to the opening.

The liner 11 is a resin member that defines a storage space 15 charged with high-pressure hydrogen gas, and is provided along the inner surface of the first reinforcement layer 12. The resin constituting the liner 11 is preferably a resin having good performance of retaining the charged gas in the storage space 15, that is, good gas barrier property. The liner 11 includes a cylindrical portion 111 and substantially hemispherical dome portions 112 disposed at right and left ends of the cylindrical portion 111 in the axial direction L, respectively. The cylindrical portion 111 and the dome portions 112 have substantially the same thickness, and are connected and integrated at boundary portions 113.

The neck 14 is made by processing a metal material, such as stainless steel or aluminum, into a predetermined shape. A valve (not shown) for charging and discharging hydrogen gas in and from the storage space 15 is attached to the neck 14.

The first reinforcement layer 12 has a function of covering the outer surface of the liner 11 and of reinforcing the liner 11 to improve mechanical strength such as rigidity and pressure resistance of the high-pressure tank 10. The first reinforcement layer 12 is preferably adhered to the liner 11. With the configuration above, creation of a clearance between the first reinforcement layer 12 and the liner 11 can be suppressed. As shown in FIG. 1, the first reinforcement layer 12 includes a cylindrical member 121 and two dome members 122, 123 disposed at respective ends of the cylindrical member 121 in an axial direction of the cylindrical member 121 (that is, the axial direction L of the high-pressure tank 10).

The cylindrical member 121 is a member corresponding to the cylindrical portion 111 of the liner 11, and is disposed in close contact with the outer surface of the cylindrical portion 111. The dome member 122 and the dome member 123 are members corresponding to the dome portions 112 disposed at the left and right ends of the liner 11, respectively, and are disposed in close contact with the outer surfaces of the dome portions 112. The cylindrical member 121 and the dome members 122, 123 are integrally joined.

The first reinforcement layer 12 is composed of resin and fibers (continuous fibers). In the cylindrical member 121, the fibers forms a circumferential shape at an angle substantially orthogonal to the axial direction L of the cylindrical member 121. In other words, in the cylindrical member 121, the fibers are oriented in a circumferential direction of the cylindrical member 121. With the configuration above in which the fibers are arranged on the cylindrical member 121 to be oriented in the circumferential direction of the cylindrical member 121, the strength of the first reinforcement layer 12 against a hoop stress generated by an internal pressure (gas pressure) can be ensured with an appropriate quantity of the fiber reinforced resin.

In the dome members 122, 123, the fibers are not oriented in the circumferential direction of the cylindrical member 121, and the fibers extending in various directions intersecting the circumferential direction are disposed so as to overlap each other. With the configuration above, the dome members 122, 123 can secure the strength of the first reinforcement layer 12 against the stress generated by the internal pressure of the fibers with an appropriate quantity of the fiber reinforced resin.

In the embodiment, the fibers of the cylindrical member 121 and the fibers of the dome members 122, 123 are not continuous (not connected). The above is because, as will be described later, after the cylindrical member 121 and the two dome members 122, 123 are separately formed, the two dome members 122, 123 are attached to respective ends of the cylindrical member 121.

The second reinforcement layer 13 is formed so as to cover the outer surface of the first reinforcement layer 12. The second reinforcement layer 13 covers the entire cylindrical member 121 and the dome members 122, 123. The second reinforcement layer 13 is composed of resin and fibers (continuous fibers).

In the embodiment, the liner 11 is made of a resin material having a shrinkage amount that is calculated using Equation (1) as shown below being 0 or less. Equation (1)

Shrinkage amount=−1.533538e−03*x1−3.82355406*x2−7.81992308*x3+1.89342646e−01*x4−7.84558163e−03*x5+1.15956871e−03*x1x2+6.29564353e−04*x1x3−9.34550213e−06*x1x4−6.59253799e−04*x1x5−1.52692282e+00*x2\hat{ }2+1.67290964e+00*x2x3−1.85202252e−02*x2x4−1.79615713e+00*x2x5+2.37163664e+00*x3\hat{ }2−1.17467786e−02*x3x4−9.04442817e−01*x3x5−1.86321584e−03*x4\hat{ }2+6.62631756e−03*x4x5+1.27572698e*x5\hat{ }2

In Equation (1), x1 denotes the minimum working pressure of the high-pressure tank 10, x2 denotes a radius of the boundary portions 113 between the cylindrical portion 111 and the dome portions 112, x3 denotes the thickness of the liner 11, x4 denotes a linear expansion coefficient of the liner 11, and x5 denotes Young's modulus of the liner 11.

Here, the minimum working pressure x1 refers to the internal pressure when the high-pressure tank 10 is empty (in other words, the hydrogen gas in the high-pressure tank 10 is used up). The radius x2 refers to a curvature of a curved portion of each of the boundary portions 113 between the cylindrical portion 111 and the corresponding dome portion 112 on the dome portion 112 side, and is so-called bending inner radius R. The radius x2 is measured, for example, at room temperature.

The thickness x3 of the liner 11 may be the thickness of the cylindrical portion 111 or the thickness of the dome portions 112 because the thickness of the entire liner 11 is the same. However, the thickness x3 of the liner 11 is preferably the thickness of the cylindrical portion 111 that is less variable. The linear expansion coefficient x4 has a temperature range from the minimum operating temperature of the high-pressure tank 10 (for example, −48.5° C.) to 23° C. The Young's modulus x5 is Young's modulus at the minimum operating temperature of the high-pressure tank 10.

Examples of the resin material forming the liner 11 include silicon resin, polyphenylene sulfide, polybutylene terephthalate, polyvinyl chloride, polypropylene, polyethylene, polycarbonate, epoxy resin, and polyamide resin.

Here, the background of the disclosure will be described.

As described above, the liner repeats expansion and shrinkage due to repeated temperature changes caused by repeated use of the high-pressure tank from when the time when the high-pressure tank is fully charged to the time when the high-pressure tank is empty. The environment of use of the high-pressure tank ranges broadly (for example, the temperature ranges from −48.5° C. to 85° C.). When the liner shrinks under a low-temperature, low-pressure environment, the liner is stretched when charged with gas such as hydrogen gas. In addition, the liner does not shrink evenly throughout, and tends to shrink partially on one side (on the dome portion side). Therefore, an excessive stress is generated on the dome portion side where the shrinkage amount is large, and this excessive local stress may adversely affect the strength of the high-pressure tank. On the basis of the above, as a result of diligent research, the inventors of the present application have found that when the shrinkage amount of the liner is set to 0, occurrence of the excessive stress on the dome portion side can be suppressed, which makes it possible to ensure the strength of the high-pressure tank. This leads to completion of the disclosure.

Specifically, the inventors of the present application first extracted factors that contribute to the shrinkage of the liner and factors that hinder the shrinkage. The linear expansion coefficient and Young's modulus of the liner were extracted as the factors that contribute to the shrinkage, and the minimum working pressure of the high-pressure tank, the radius of the boundary portion between the cylindrical portion and the dome portion, and the thickness of the liner were extracted as the factors that hinder the shrinkage.

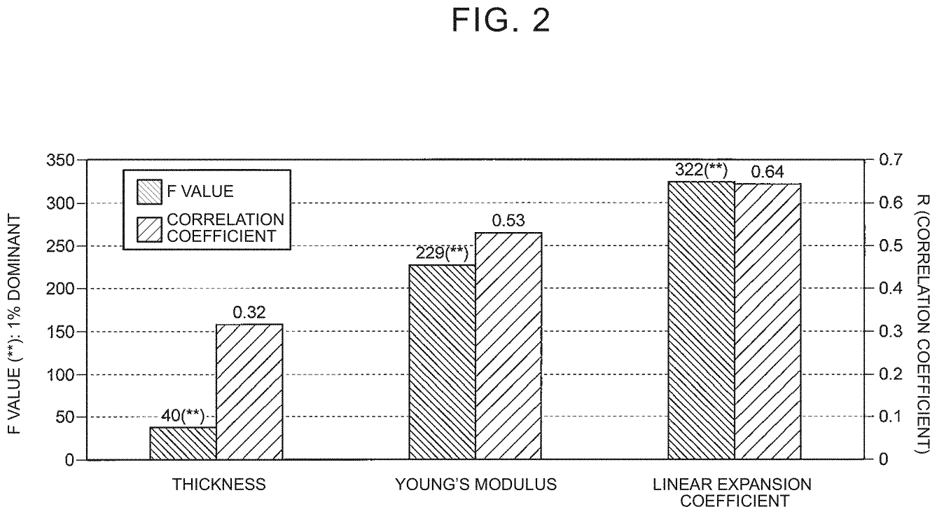

Next, among the extracted factors, the minimum working pressure and the radius were set to have constant values, and correlations among the thickness of the liner, Young's modulus, and the linear expansion coefficient with the shrinkage amount were investigated, using the computer aided engineering (CAE), with the levels of the thickness of the liner, Young's modulus, and the liner expansion coefficient shown in Table 1. The results are shown in FIG. 2. It was found based on the results shown in FIG. 2 that the linear expansion coefficient has the largest correlation with the shrinkage amount, followed by Young's modulus, and the smallest is the thickness (that is, the thickness of the liner).

TABLE 1

| | Thickness of the liner | Young's modulus | Linear expansion |
|---|---|---|---|
| | [mm] | [GPa] | coefficient [10⁻⁴/K] |
| | (3 levels) | (4 levels) | (4 levels) |
| Levels | 1.0 | 1.0 | 0.5 |
| | 2.0 | 3.0 | 1.0 |
| | 3.0 | 5.5 | 1.5 |
| | — | 8.0 | 2.0 |

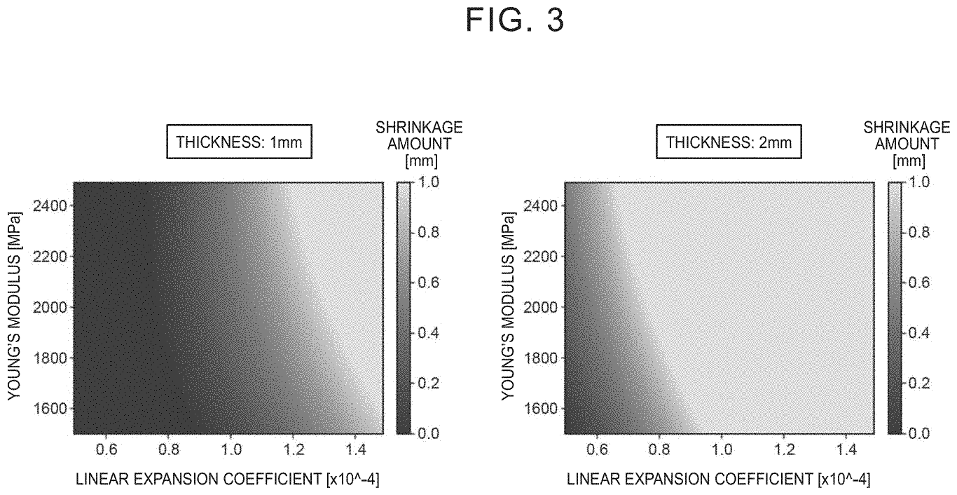

Next, the inventors of the present application used an epoxy resin and investigated the relations of the linear expansion coefficient, Young's modulus, and the shrinkage amount under the following conditions: the thickness of liners: 1 millimeter (mm) or 2 millimeters; the minimum working pressure of the high-pressure tank: 0.7 Mpa; the minimum working temperature: −48.5° C.; the radius: 20 millimeters; the liner expansion coefficient: 0.8×10\hat{ }−4; and Young's modulus: 1800 MPa. The results are shown in FIG. 3. In FIG. 3, a contour diagram on the left side shows the result for the case where the thickness of the liner is 1 millimeters, and a contour diagram on the right side shows the result for the case where the thickness of the liner is 2 millimeters.

As shown in FIG. 3, as the linear expansion coefficient and Young's modulus increase, the shrinkage amount increases. Further, it has been found that, when the minimum working pressure, the minimum working temperature, the radius, the linear expansion coefficient and Young's modulus are the same, the shrinkage amount decreases as the thickness of the liner decreases.

On the basis of the investigation results described above, the inventors of the present application have found that use of the resin material that satisfies the condition specified in Equation (1) above makes it possible to reduce the shrinkage amount of the formed liner to be zero (0) or less. Here, all the cases where the shrinkage amount is 0 or less are regarded as 0.

In the high-pressure tank 10 according to the embodiment, the liner 11 is formed of the resin material having the shrinkage amount that is calculated using Equation (1) being 0 or less. Therefore, the shrinkage amount of the liner 11 due to temperature changes can be reduced to 0. Consequently, the strength of the high-pressure tank 10 can be ensured even when the thickness of the liner 11 is reduced.

Manufacturing Method of High-Pressure Tank

Hereinafter, a manufacturing method of the high-pressure tank 10 will be described. The manufacturing method of the high-pressure tank 10 includes a reinforcement layer forming step of forming a reinforcement layer having the first reinforcement layer 12 and the second reinforcement layer 13, and a liner forming step of forming the liner 11 on an inner side of the first reinforcement layer 12, and a curing step of simultaneously curing the liner 11, the first reinforcement layer 12, and the second reinforcement layer 13 that are formed in the steps above. The reinforcement layer forming step further includes a first reinforcement layer forming step of forming the first reinforcement layer 12, and a second reinforcement layer forming step of forming the second reinforcement layer 13 on an outer side of the first reinforcement layer 12.

First, in the first reinforcement layer forming step, for example, a filament winding process (FW process) is used to wind resin-impregnated fibers around a predetermined mold so as to cover an outer surface of the mold to prepare a wound body. The produced wound body is cut into two dome members 122, 123 using a cutter, etc. In the processing above, one of the formed dome members 122, 123 (the dome member 122 in the embodiment) has an opening.

The resin impregnated in the fibers is not particularly limited, but it is preferable to use a thermosetting resin such as an epoxy resin. Further, as the fibers, carbon fibers, glass fibers, aramid fibers, and boron fibers, for example, may be used.

Subsequently, the cylindrical member 121 is formed, for example, using the centrifugal winding (CW) process, by attaching a fiber sheet impregnated with resin to an inner surface of a rotating cylindrical mold. The fiber sheet impregnated with resin includes, for example, at least fibers oriented in a circumferential direction of the cylindrical mold. With the processing above, the cylindrical member 121 in which the fibers are oriented in the circumferential direction can be obtained. The resin impregnated in the fiber sheet is not particularly limited, but it is preferable to use a thermosetting resin such as an epoxy resin as in the case of forming the dome members 122, 123.

Subsequently, after the neck 14 is attached to the dome member 122 having the opening, end portions of the cylindrical member 121 and end portions of the two dome members 122, 123 are joined to each other to form the first reinforcement layer 12.

In the second reinforcement layer forming step, the second reinforcement layer 13 made of the fiber reinforced resin material is formed using, for example, the filament winding process with fibers impregnated with resin so as to cover the outer surface of the first reinforcement layer 12, that is, the cylindrical member 121 and the two dome members 122, 123. Here, as the resin impregnated in the fibers, a thermosetting resin such as an epoxy resin is used as in the case of forming the first reinforcement layer 12. Further, as the fibers, carbon fibers, glass fibers, aramid fibers, and boron fibers, for example, are used as in the case of forming the first reinforcement layer 12.

In the liner forming step, the resin material is injected into the inside of the first reinforcement layer 12 formed in the reinforcement layer forming step via the neck 14, and the first reinforcement layer 12 and the second reinforcement layer 13 formed in the reinforcement layer forming step are rotated such that the injected resin material covers the inner surface of the first reinforcement layer 12, and the resin material is solidified to some extent. The liner 11 is formed in this procedure.

In the liner forming step, the liner 11 is manufactured using the resin material having the shrinkage amount that is calculated using Equation (1) above being 0 or less. As the resin material, a thermosetting resin such as an epoxy resin is used as in the case of forming the first reinforcement layer 12 and the second reinforcement layer 13.

In the curing step, the liner 11, the first reinforcement layer 12, and the second reinforcement layer 13 formed in the steps described above are placed in a thermosetting furnace and heated at a temperature of, for example, 160° C. for 10 minutes to thermally cure the uncured liner 11 and the thermosetting resin impregnated in the fibers used in the first reinforcement layer 12 and the second reinforcement layer 13 simultaneously. With the processing above, the high-pressure tank 10 is manufactured.

In the manufacturing method of the high-pressure tank according to the embodiment, in the liner forming step, the liner 11 is formed of the resin material having the shrinkage amount that is calculated using Equation (1) above being 0 or less. Therefore, the shrinkage amount of the liner 11 due to temperature changes can be reduced to 0. Consequently, the strength of the high-pressure tank 10 can be ensured even when the thickness of the liner 11 is reduced.

In addition, the resin impregnated in the fibers used in the first reinforcement layer 12 and the second reinforcement layer 13 is the same as the resin material used for forming the liner 11 (here, the epoxy resin), and the liner 11, the first reinforcement layer 12, and the second reinforcement layer 13 formed in the steps above are cured simultaneously. Therefore, compared with the case where the liner is formed of a different resin material from the material used for forming the first reinforcement layer 12 and the second reinforcement layer 13, and the liner, the first reinforcement layer 12 and the second reinforcement layer 13 are cured at different timings, the number of the manufacturing steps can be reduced.

Modification

In the above description, the case where the high-pressure tank 10 includes the liner 11, and the first reinforcement layer 12 and the second reinforcement layer 13 that cover the outer surface of the liner 11 is described as an example. However, the high-pressure tank of the disclosure may include only a single reinforcement layer that covers the outer surface of the liner. When manufacturing the high-pressure tank having the configuration above, the liner is preliminary formed of the resin material having the shrinkage amount that is calculated using Equation (1) above being 0 or less. The reinforcement layer is then formed by winding the reinforced fibers impregnated with a thermosetting resin on the outer surface of the formed liner by hoop winding or helical winding. The liner and the reinforcement layer are thermally cured after that. Even in the case above, the shrinkage amount of the liner due to the temperature changes can be reduced to 0. Accordingly, the strength of the high-pressure tank can be ensured even when the thickness of the liner is reduced.

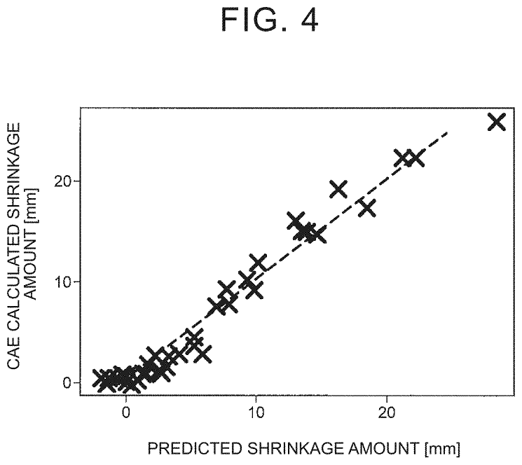

Further, in order to confirm reliability of the shrinkage amount calculated using Equation (1) above, the inventors of the present application made a comparison between the shrinkage amount (predicted shrinkage amount) that is calculated using Equation (1) above and the shrinkage amount (CAE calculated shrinkage amount) that is calculated using the computer aided engineering (CAE) under conditions that the minimum working pressure, the radius, the thickness of the liner, the linear expansion coefficient, Young's modulus, and the resin material used are all identical. The comparison results are shown in FIG. 4. FIG. 4 shows a two-dimensional linear regression of the comparison results of the predicted shrinkage amount and the CAE calculated shrinkage amount. The results show that a coefficient of determination R² was 0.97 and a mean square error E was 1.26. With the result above, an error between the calculated shrinkage amount using Equation (1) above and the calculated shrinkage amount using CAE is small, and it has been proved that reliability of the shrinkage amount calculated using Equation (1) above is high.

Although the embodiment of the disclosure has been described in detail above, the disclosure is not limited to the embodiment described above, and various design changes can be made without departing from the spirit of the disclosure described in the claims.

What is claimed is:

1. A high-pressure tank, comprising
a liner including a cylindrical portion and dome portions disposed at respective ends of the cylindrical portion in an axial direction of the cylindrical portion, wherein the liner is made of a material having a shrinkage amount that is calculated by an equation below being 0 or less,
the equation being
shrinkage amount=−1.533538e−03*x1−3.82355406*x2−7.81992308*x3+1.89342646e−01*x4−7.84558163e−03*x5+1.15956871e−03*x1x2+6.29564353e−04*x1x3−9.34550213e−06*x1x4−6.59253799e−04*x1x5−1.52692282e+00*x2\hat{ }2+1.67290964e+00*x2x3−1.85202252e−02*x2x4−1.79615713e+00*x2x5+2.37163664e+00*x3\hat{ }2−1.17467786e−02*x3x4−9.04442817e−01*x3x5−1.86321584e−03*x4\hat{ }2+6.62631756e−03*x4x5+1.27572698e*x5\hat{ }2,
where x1 denotes a minimum working pressure of the high-pressure tank, x2 denotes a radius of a boundary portion between the cylindrical portion and each of the dome portions, x3 denotes a thickness of the liner, x4 denotes a linear expansion coefficient of the liner, and x5 denotes Young's modulus of the liner.

2. The high-pressure tank according to claim 1, further comprising a reinforcement layer configured to cover an outer surface of the liner, wherein the reinforcement layer and the liner are adhered to each other.

3. A manufacturing method of a high-pressure tank, comprising:
a liner forming step of forming a liner including a cylindrical portion and dome portions disposed at respective ends of the cylindrical portion in an axial direction of the cylindrical portion; and
a reinforcement layer forming step of forming a reinforcement layer configured to cover an outer surface of the liner, wherein
one of the liner forming step and the reinforcement layer forming step is performed, and then the other of the liner forming step and the reinforcement layer forming step is performed, and wherein
in the liner forming step, the liner is formed of a material having a shrinkage amount that is calculated using an equation below being 0 or less,
the equation being
shrinkage amount=−1.533538e−03*x1−3.82355406*x2−7.81992308*x3+1.89342646e−01*x4−7.84558163e−03*x5+1.15956871e−03*x1x2+6.29564353e−04*x1x3−9.34550213e−06*x1x4−6.59253799e−04*x1x5−1.52692282e+00*x2\hat{ }2+1.67290964e+00*x2x3−1.85202252e−02*x2x4−1.79615713e+00*x2x5+2.37163664e+00*x3\hat{ }2−1.17467786e−02*x3x4−9.04442817e−01*x3x5−1.86321584e−03*x4\hat{ }2+6.62631756e−03*x4x5+1.27572698e*x5\hat{ }2,
where x1 denotes a minimum working pressure of the high-pressure tank, x2 denotes a radius of a boundary portion between the cylindrical portion and each of the dome portions, x3 denotes a thickness of the liner, x4 denotes a linear expansion coefficient of the liner, and x5 denotes Young's modulus of the liner.

4. The manufacturing method of the high-pressure tank according to claim 3, wherein:
in the reinforcement layer forming step, a resin impregnated in a fiber is used;
the resin impregnated in the fiber is the same as the material forming the liner; and
after performing the liner forming step and the reinforcement layer forming step, the liner and the reinforcement layer are cured simultaneously.
